(19) United States
(12) Patent Application Publication
(10) Pub. No.: US 2016/0113238 A1
(43) Pub. Date: Apr. 28, 2016

(54) Multi-Level, Pet Accessible Home

(71) Applicant: Dennis Justiniano, Lowell, MA (US)

(72) Inventor: Dennis Justiniano, Lowell, MA (US)

(21) Appl. No.: 14/923,423

(22) Filed: Oct. 26, 2015

Related U.S. Application Data
(63) Continuation-in-part of application No. 29/484,823, filed on Mar. 13, 2014, now Pat. No. D742077.
Application No. 29/484,823 is a continuation-in-part of application No. 29/510,928, filed on Dec. 4, 2014.

(51) Int. Cl. A01K 1/035; A01K 1/00

(52) U.S. Cl. CPC A01K 1/035; A01K 1/0035

(57) ABSTRACT

A multi-level, accessible home for pets with a building structure with at least a first story with first floor flooring, a second story with second floor flooring, a plurality of outer walls, and a roof supported by the outer walls. A first floor door is disposed in an outer wall of the building structure for permitting ingress and egress relative to first story of the building structure, and a vertical communication connection, such as stairs, connects the first floor flooring to the second floor flooring. A second floor door can be disposed in an outer wall of the building structure, and a porch can be retained by the building structure adjacent to the second floor door. An indoor/outdoor sustenance retention system can be adjustable between a refracted position and an extended position. The second story and the roof can be removable as a unit.

This application is a continuation-in-part of application Ser. No. 29/484,823, filed Mar. 13, 2014, and application Ser. No. 29/510,928, filed Dec. 4, 2014, the entire disclosure of each application being incorporated herein by reference.

### FIELD OF THE INVENTION

The present invention relates generally to building structures. More particularly, disclosed herein is multi-level home with accessibility and accommodation for dogs and other pets.

### BACKGROUND OF THE INVENTION

The prior art has disclosed numerous specially-constructed homes for dogs and other pets. For the most part, such dog houses have been decidedly Spartan in structure and appearance. They have sought only to protect the animal from the elements, to provide a measure of protection against the cold in the cooler months, and to provide cool shade during summer. Borne out of practical necessity, dog houses of the prior art have typically provided little beyond a roof over the animal's head. They have often been relatively unattractive and not complementary to the property on which they are disposed. Moreover, such rudimentary structures have provided little enjoyment or entertainment to the animal but instead provided a plain, one-room shelter with no connection to the world outside.

It has thus become apparent to the present inventor that there is a need in the art for a home for pets that provides accessible shelter specially adapted to accommodate pets while providing an enjoyable and entertaining habitat for the animal and an attractive complement to the pet owner's home.

### SUMMARY OF THE INVENTION

In view of the foregoing, the present inventor set forth with the basic object of providing a home for pets that provides enjoyment, comfort, and entertainment to pet and pet owner alike.

A related object of embodiments of the invention is to provide a home for pets that provides multiple stories of shelter and varied accommodation and living space to the pet.

Embodiments of the invention have the further object of providing a home for pets that permits convenient ingress and egress to the animal while providing maximum floor space for rest and recreation.

Certain embodiments of the invention have the object of providing ready access to the interior of the home for pets for maintenance, improvement, and pet interaction.

Still another object of the invention is to provide a home for pets that permits the pet to have access to food and water both from within the interior of the home and from exterior to the home.

A further object of embodiments of the invention is to provide a home for pets that enables automation, such as in water or food supply, door operation, or otherwise.

Embodiments of the invention have the additional object of providing a home for pets that permits remote monitoring of the pet by the caregiver.

An additional object of the invention is to provide a home for pets that provides electrical power throughout the home for lighting and other electrical power supply functionality.

These and further objects and advantages of embodiments of the invention will become obvious not only to one who reviews the present specification and drawings but also to those who have an opportunity to enjoy the use of an embodiment of the home for pets disclosed herein. However, it will be appreciated that, although the accomplishment of each of the foregoing objects in a single embodiment of the invention may be possible and indeed preferred, not all embodiments will seek or need to accomplish each and every potential object and advantage. Nonetheless, all such embodiments should be considered within the scope of the present invention.

One will appreciate that the foregoing discussion broadly outlines the more important goals and features of the invention to enable a better understanding of the detailed description that follows and to instill a better appreciation of the inventor's contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

In the accompanying drawings:

FIG. 1 is a perspective view of the Multi-Level, Accessible Home for Pets showing the door to the balcony in an open position;

FIG. 2 is a perspective view of the Multi-Level, Accessible Home for Pets showing the door to the balcony in a closed position;

FIG. 3 is a left side elevational view of the Multi-Level, Accessible Home for Pets;

FIG. 4 is a right side elevational view of the Multi-Level, Accessible Home for Pets;

FIG. 5 is a front elevational view of the Multi-Level, Accessible Home for Pets;

FIG. 6 is a rear elevational view of the Multi-Level, Accessible Home for Pets;

FIG. 7 is a bottom plan view of the Multi-Level, Accessible Home for Pets;

FIG. 8A is a perspective view of the Multi-Level, Accessible Home for Pets showing the roof pivoted to an open position and the feeding tray opened to an extended position;

FIG. 8A is a perspective view of the Multi-Level, Accessible Home for Pets showing the roof pivoted to an open position and the feeding tray opened to an extended position;

FIG. 8B is a top plan view of the Multi-Level, Accessible Home for Pets with the second floor and roof removed;

FIG. 9 is a cross-section of the Multi-Level, Accessible Home for Pets taken along the line 9-9 in FIG. 3;

FIG. 10 is a cross-section of the Multi-Level, Accessible Home for Pets taken along the line 10-10 in FIG. 4;

FIG. 11 is a cross-section of the Multi-Level, Accessible Home for Pets taken along the line 11-11 in FIG. 5;

FIG. 12 is a cross-section of the Multi-Level, Accessible Home for Pets taken along the line 12-12 in FIG. 6;

FIG. 13 is a perspective view of a Gazebo for Pets as disclosed herein;

FIG. 14 is a left side elevational view of the Gazebo for Pets;

FIG. 15 is a right side elevational view of the Gazebo for Pets;

FIG. 16 is a front elevational view of the Gazebo for Pets;

FIG. 17 is a rear elevational view of the Gazebo for Pets;

FIG. 18 is a bottom plan view of the Gazebo for Pets;

FIG. 19 is a top plan view of the Gazebo for Pets;

FIG. 20 is a perspective view of the Gazebo for Pets with the roof removed;

FIG. 21 is a perspective view of the Gazebo for Pets coupled to the Multi-Level, Accessible Home for Pets; and

FIG. 22 is a front elevational view the Gazebo for Pets coupled to the Multi-Level, Accessible Home for Pets.

### DETAILED DESCRIPTION OF PREFERRED EMBODIMENTS

The invention for a multi-level, accessible home for pets disclosed herein is subject to widely varied embodiments. However, to ensure that one skilled in the art will be able to understand and, in appropriate cases, practice the present invention, certain preferred embodiments of the broader invention revealed herein are described below and shown in the accompanying drawing figures.

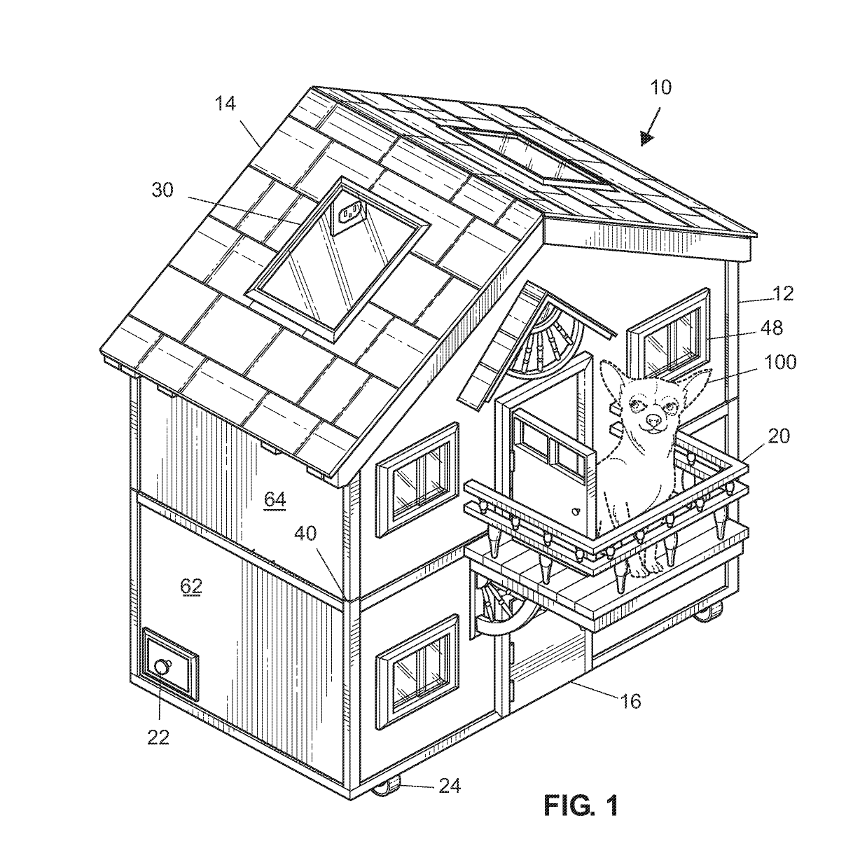

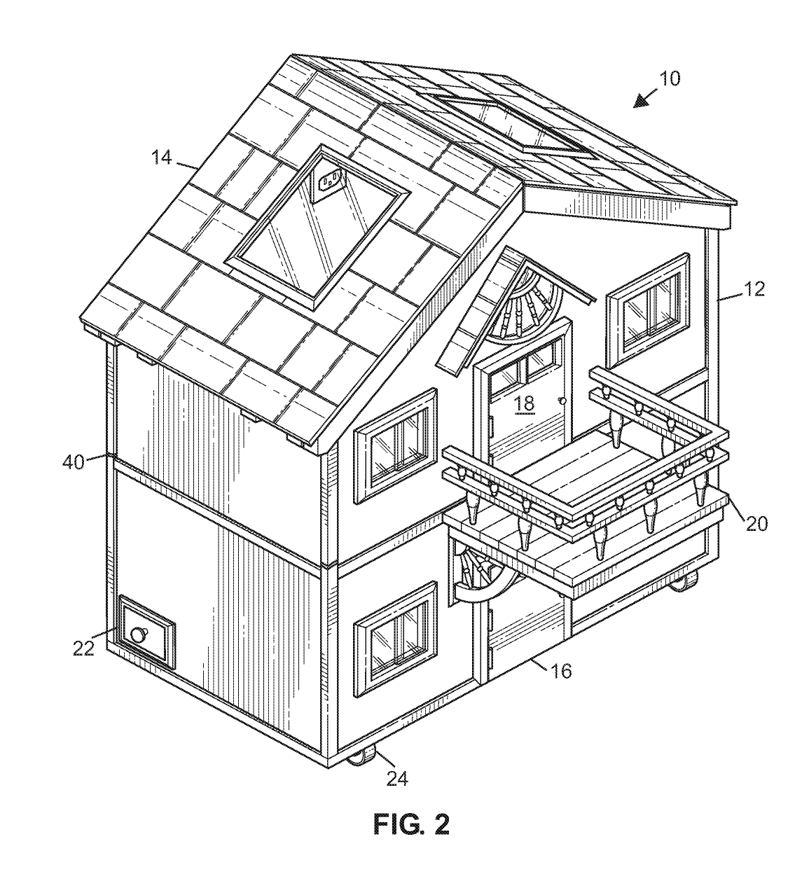

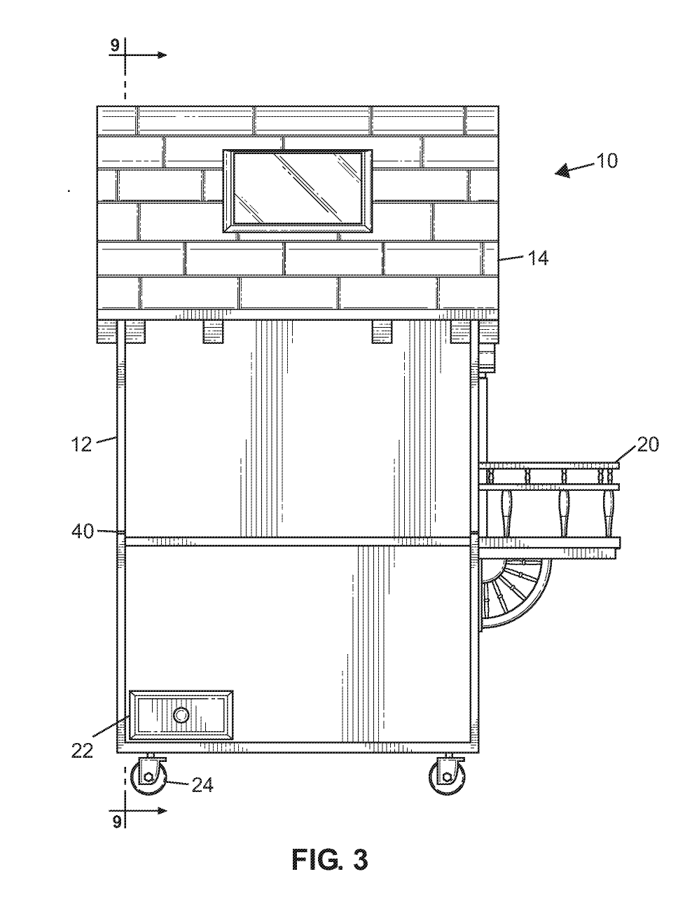

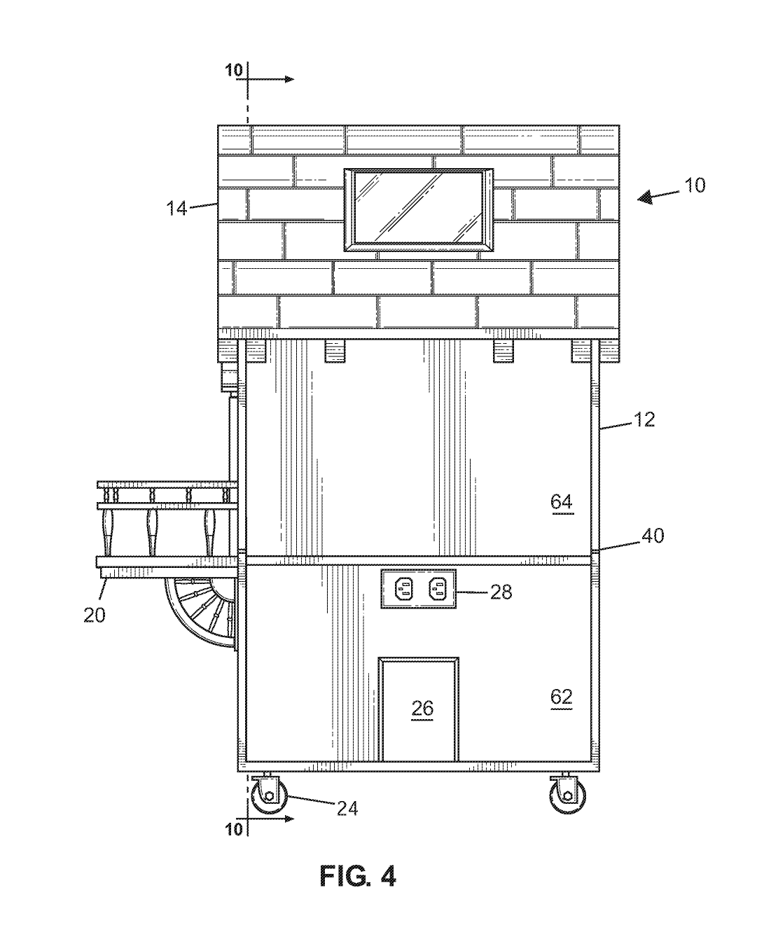

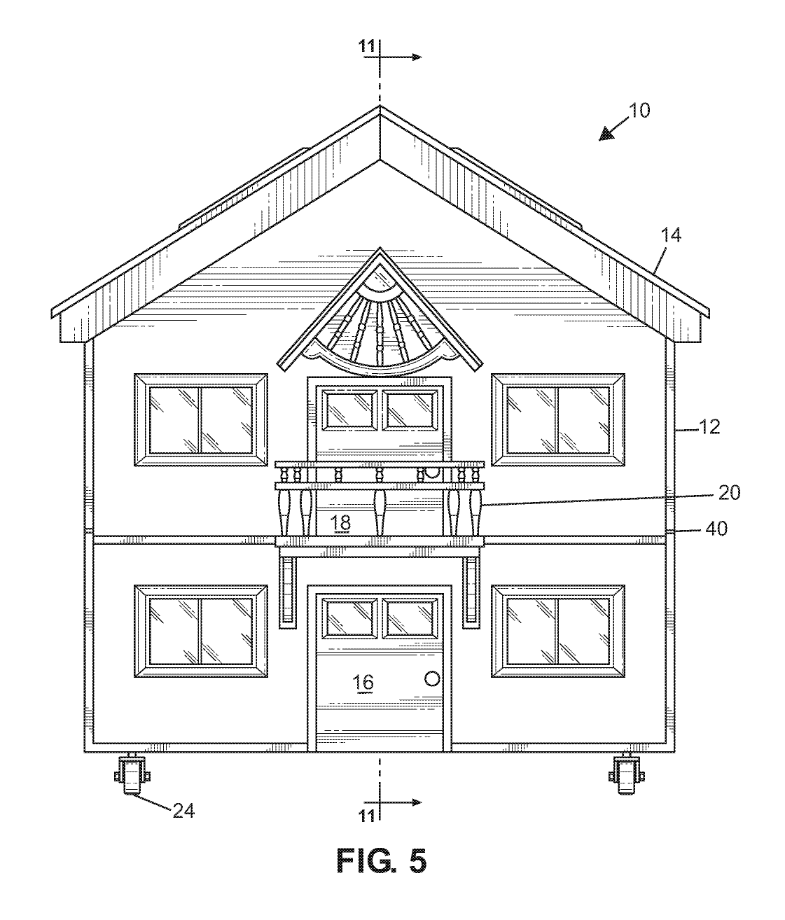

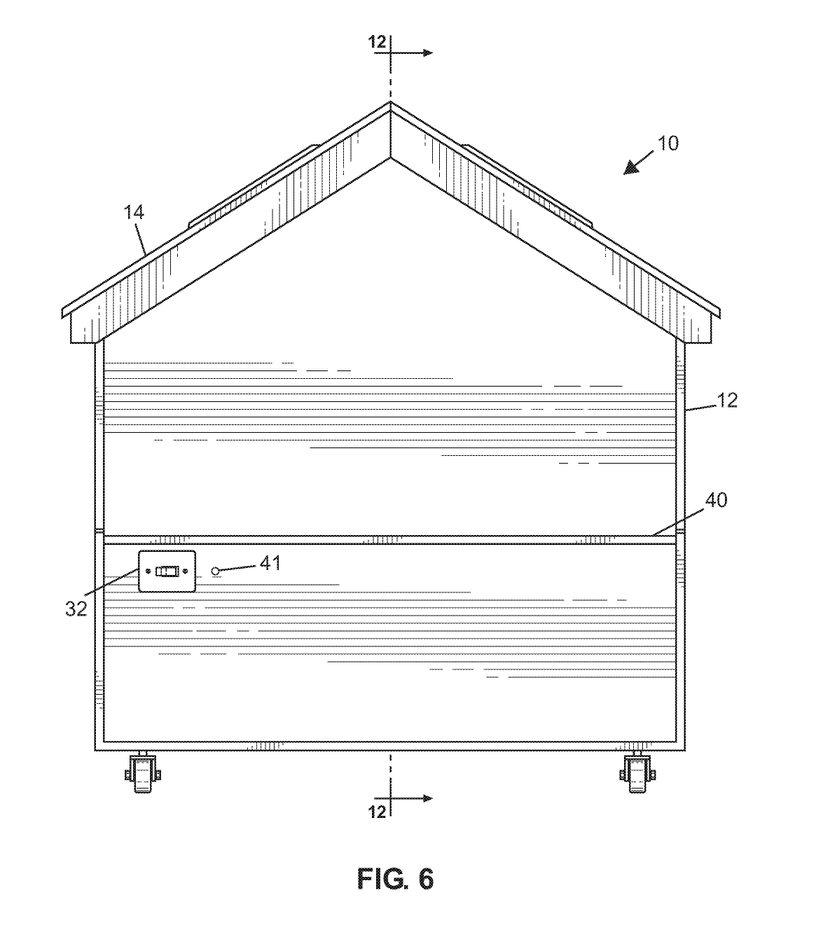

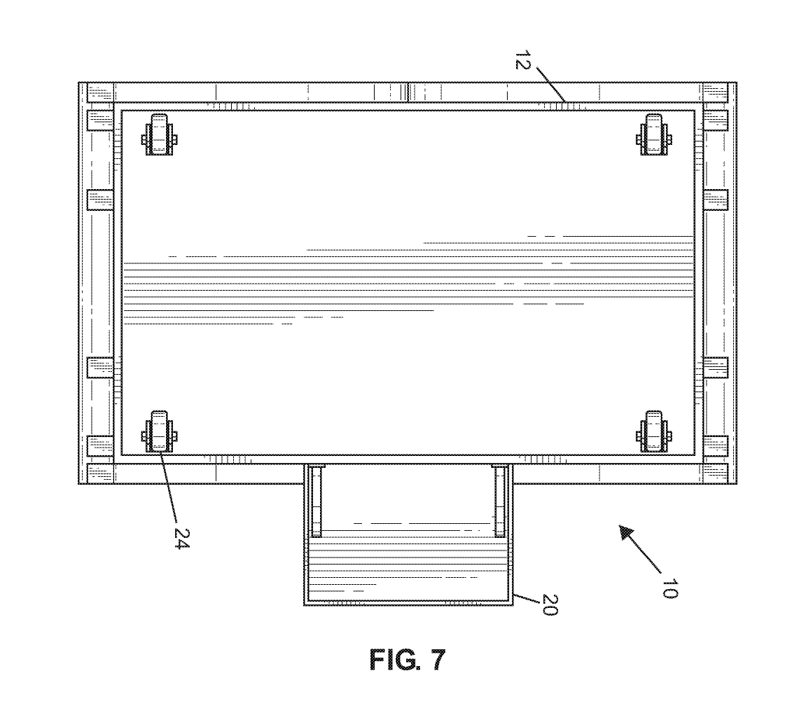

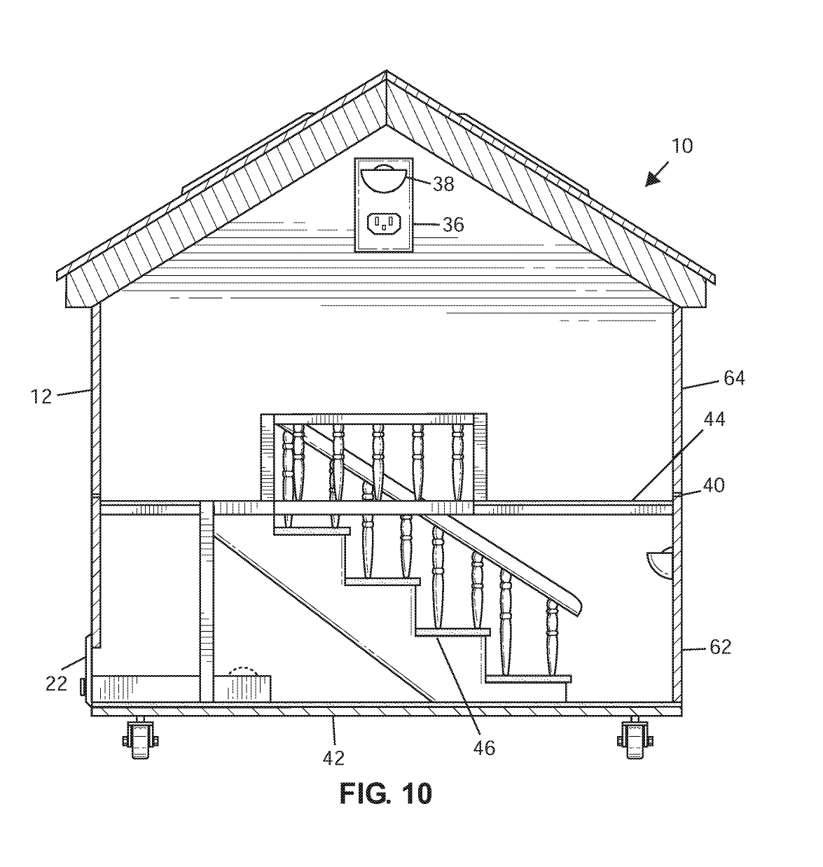

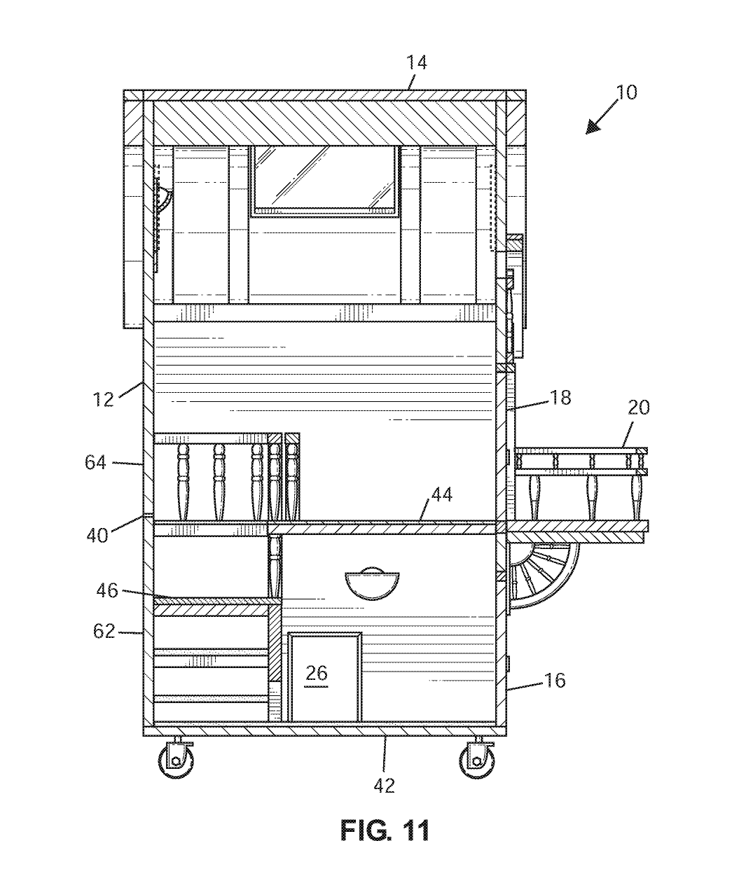

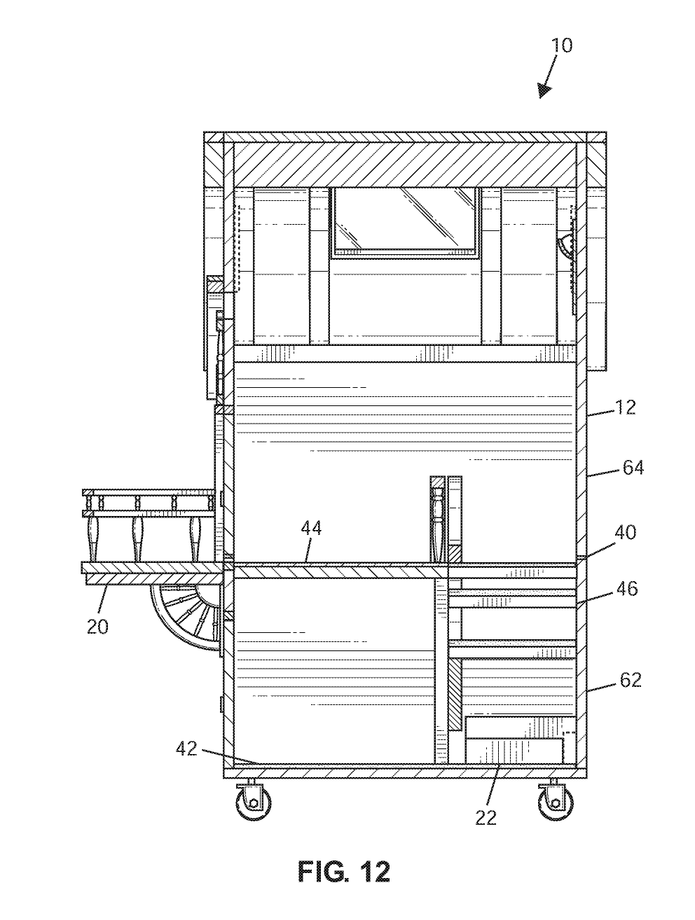

Turning more particularly to the drawings, an embodiment of a multi-level, accessible home for pets embodying the present invention is depicted generally at 10 in FIGS. 1 through 12. There, the home for pets 10 is founded on a building structure 12 with a first floor 62, a second floor 64, and a roof 14. The building structure 12 has a generally rectangular lateral cross section defined by four outer walls, namely a front wall, a rear wall, and left and right side walls. A first floor door 16 is disposed in the front wall in a lower portion of the first floor 62, and a second floor door 18 is disposed in the front wall in a lower portion of the second floor 64. A porch 20 is secured to the front wall to be generally equivalent in elevation to the lower end of the second floor door 18 and to the second floor of the home for pets 10 generally. Plural operable windows 48 are disposed in the front wall, such as with a first floor window 48 disposed to each side of the first floor door 16 and a second floor window 48 disposed to each side of the second floor door 18. Further, as can be best seen in FIG. 4, a side door 26 can be disposed in a side wall of the home for pets 10.

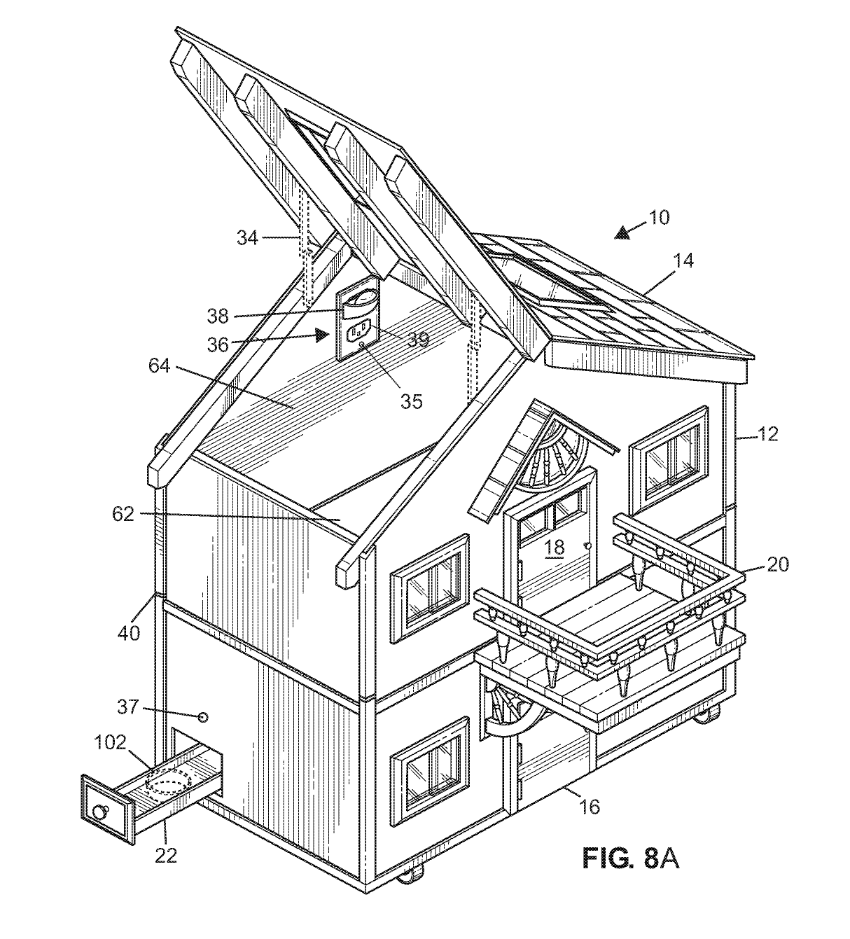

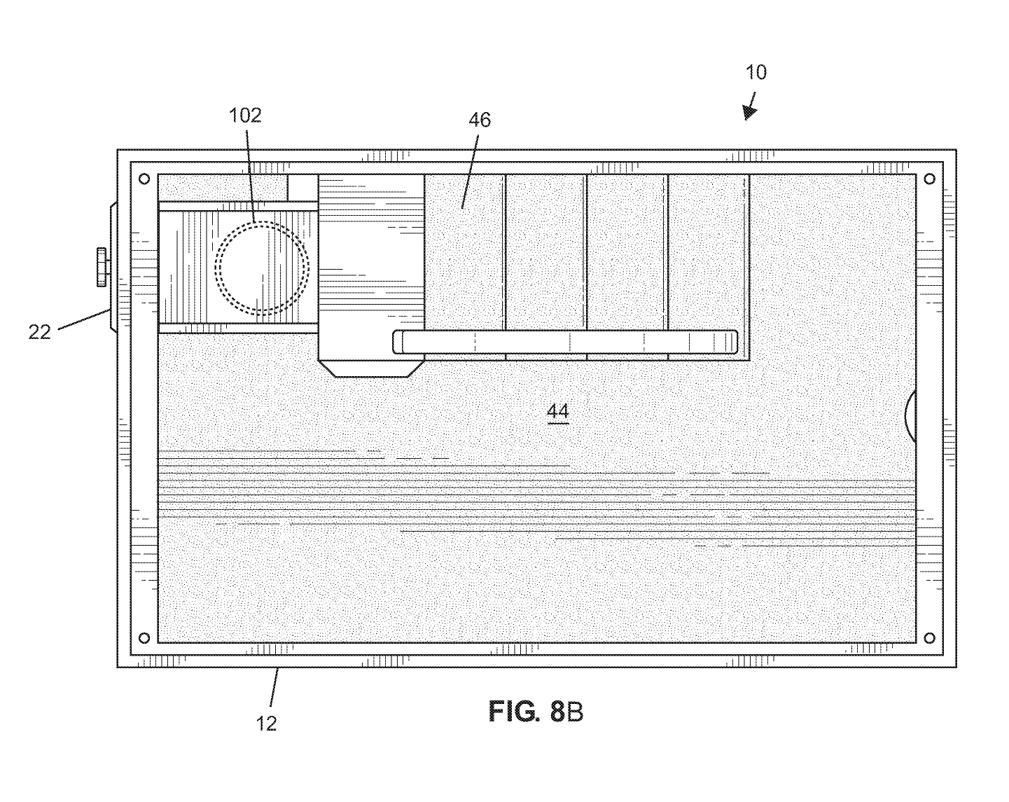

In certain embodiments of the home for pets 10, as is illustrated, one or more skylights 30 can be disposed in the roof 14 of the home 10. In the depicted embodiments, the roof 14 has left and right portions, and a first skylight 30 is disposed in the left roof portion and a second skylight 30 is disposed in the right roof portion. As FIG. 8A illustrates perhaps most clearly, either or both roof portions can be capable of being opened or removed. In this embodiment, the left roof portion is pivotable about an axis adjacent to the peak of the roof 14, and articulated support arms 34 can selectively retain the roof portion in an elevated position.

The home for pets 10 has an indoor/outdoor sustenance retention system 22. The sustenance retention system 22, can for example, be retained in relation to a wall of the home 10, such as in relation to the left side wall as illustrated. The sustenance retention system 22 has a support surface, such a walled support surface forming a tray, for retaining food and, additionally or alternatively, water for a pet. The food and water could, for example, be disposed in one or more bowls 102 or other containers. In the depicted structure, the sustenance retention system 22 has a handle and an end face that retains the handle. The walled support surface of the sustenance system is slidably retained to pass through an opening in the left side wall.

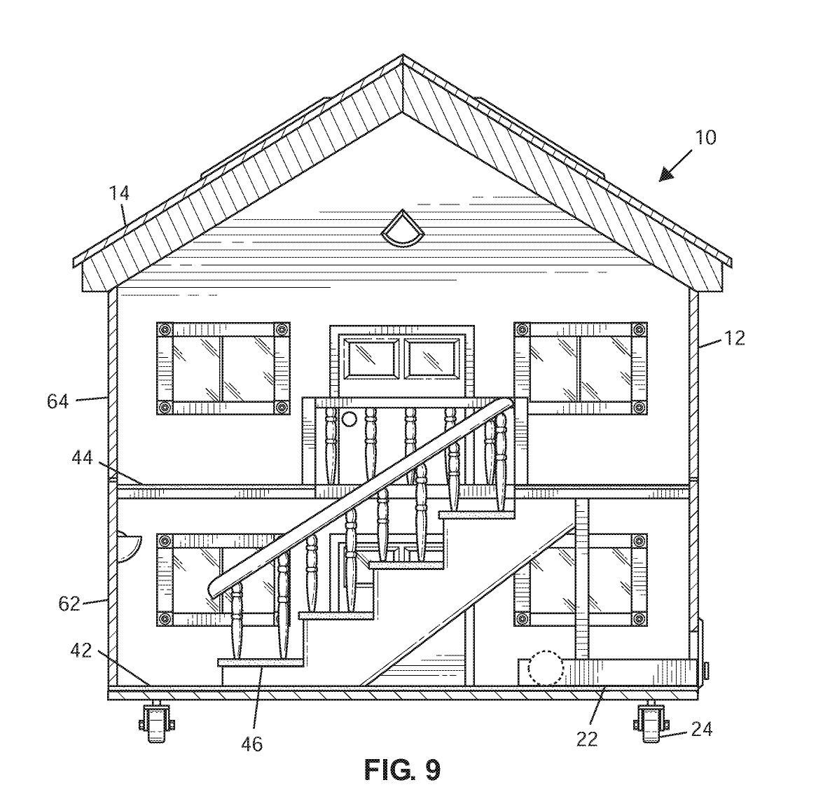

When the sustenance retention system 22 is in a retracted position as in FIGS. 1 and 9, for example, the tray will be disposed within the home 10, and the end face of the system 22 will close the aperture in the left side wall. Food and water retained by the tray will thus be accessible to a pet residing within the home 10. When the sustenance retention system 22 is in an extended position as, for example, in FIG. 8A, the tray will be disposed exterior to the home, and a pet will be able to obtain food and water while outside the home 10.

It would be possible for the sustenance retention system 22 to be operated, more particularly extended and retracted, manually, such as by the pet or by the owner. Alternatively, the sustenance retention system 22 could be extended and retracted automatically. For example, the home for pets 10 could include an electrical subsystem 36 with one or more electronic sensors and electronic actuators. One or more interior sensors 35, such as a sensor 35 disposed facing interiorly from a wall of the home 10, could thus sense when an animal is inside the home 10. An exterior sensor 37, such as a sensor 37 facing exteriorly from a wall of the home 10 adjacent to the tray, could sense when the animal is outside the home 10, such as in the vicinity of the sustenance retention system 22. The sustenance retention system 22 could be correspondingly actuated, such as to extend the tray when the animal is sensed to be seeking food or water from exterior the home 10 by the exterior sensor 37. When an animal is in the home 10, the sustenance retention system 22 could be induced to a retracted position. The tray of the system 22 could automatically be reconfigured to an extended position when an animal is outside the home adjacent to the sensor 37 or when an animal otherwise triggers the sustenance retention system 22, such as by a switch or other mechanism. Additionally or alternatively, the sustenance retention system 22 could be actuated by a timer thereby to feed and water an animal by selective extension and retraction of the tray at specified times.

The disclosed embodiment of the home for pets 10 also is provided with a plurality of wheels 24 at the bottom thereof. With that, the entire home for pets 10 can be readily relocated. As shown, the wheels 24 could comprise caster wheels 24. One wheel 24 could, by way of example, be located adjacent to each corner of the home for pets 10.

The electrical subsystem 36 of the home for pets 10 can further include one or more electrical sockets 39. As is shown in FIG. 8A, for instance, a grounded socket 39 can be disposed adjacent to the peak of the rear wall of the home 10. The socket 39 is depicted as facing interiorly, but further and differently configured sockets are contemplated. One or more lights 38 can be powered by the electrical subsystem 36. The light or lights 38 could be independently wired, or lights 38 could be included that themselves plug into a socket 39 as FIG. 8A illustrates. Further electrical sockets 28 can be disposed to be accessible from exterior to the home for pets 10 as seen, for instance, in FIG. 4 where an exterior socket 28 is disposed in the right side wall of the home for pets 10. In the present embodiment, an exterior socket 28 can thus be seen to be disposed in the first floor 62 of the home 10, and an interior socket 39 can be seen to be disposed in the second floor 64 of the home 10. Power to the sockets 28 and 39, to the lights 38, to the sensors 35 and 37, and to the electrical subsystem 36 in general can be provided, such as through a power cord 41 electrically coupled to an external source of power. A switch 32, which in this embodiment is disposed facing exteriorly on the rear wall of the home for pets 10 can selectively permit power to flow through the electrical subsystem 36.

With particular reference to FIGS. 8A through 12, the interior of the home for pets 10 can be better understood. There, the first floor 62 can be seen to be bounded at its bottom or proximally by first floor flooring 42. The second floor 64 can be seen to be bounded at its bottom or proximally by second floor flooring 44. The first floor 62 is bounded at its top or distally by the second floor flooring 44, and the second floor 64 is bounded at its top or distally by the lower portions of the roof 14.

A vertical communication connection 46 connects the first floor flooring 42 to the second floor flooring 44. It would be possible, for example, to provide a ramp (not shown) as a vertical communication connection 46 with a continuous surface along which pets could traverse between the first and second floors 62 and 64. In the depicted example, however, the connection 46 comprises a stairway 46. Other connections 46 would be possible within the scope of the invention except as it might be expressly limited by the claims. The stairway 46 has a plurality of steps that permit a pet to pass from the first floor 62 to the second floor 64 and vice-versa.

As a careful review of, for example, FIG. 1 will illustrate and as FIG. 8B depicts most clearly, the second floor 64 and roof 14 of the home for pets 10 is entirely removable from the first floor 62 thereby permitting minimally obstructed access to the interior of the home for pets 10 as may be necessary, for instance, to permit cleaning, updated, maintenance, and pet care. In the present embodiment, the walls forming the building structure 12 are bifurcated immediately above the second floor flooring 44. With that, the upper portions of the front and side walls that laterally bound the second floor 64 can be readily removed together with the roof 14. While the second story 64 of the home for pets 10 is removed, the second floor flooring 44 can remain in place, such as by being fixed to or removably retained by the lower portions of the front and side walls defining the building structure 12.

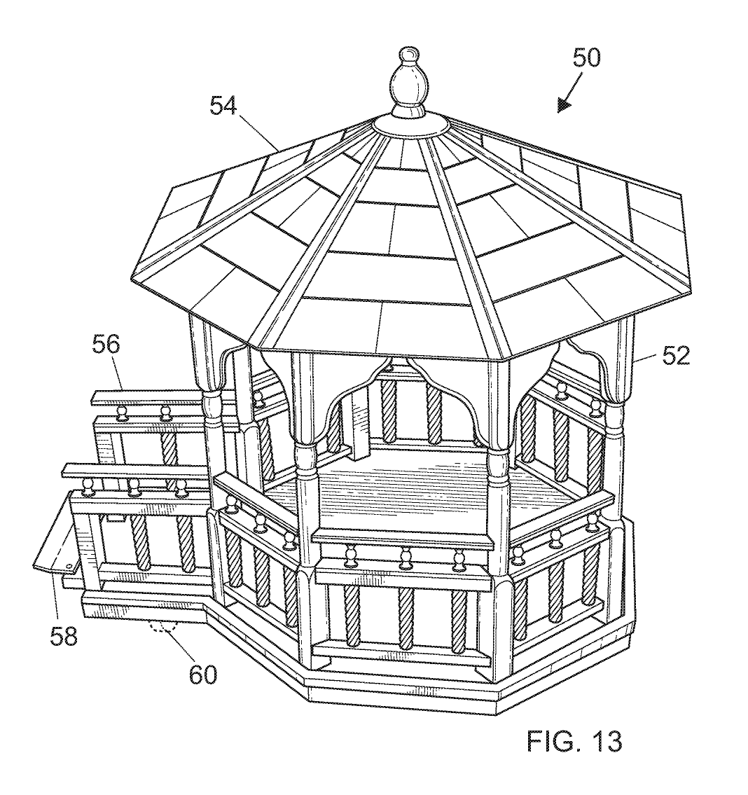

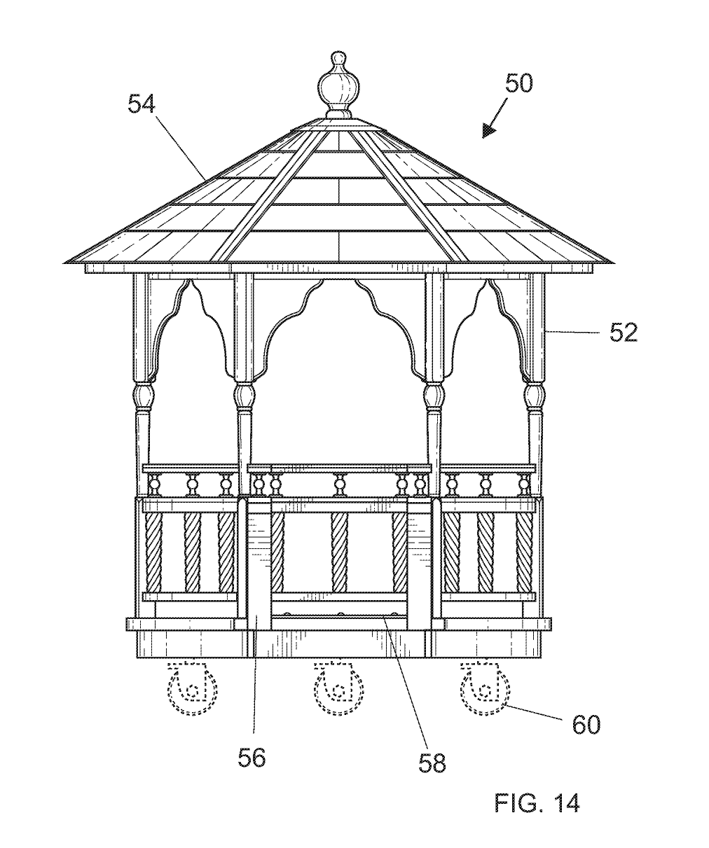

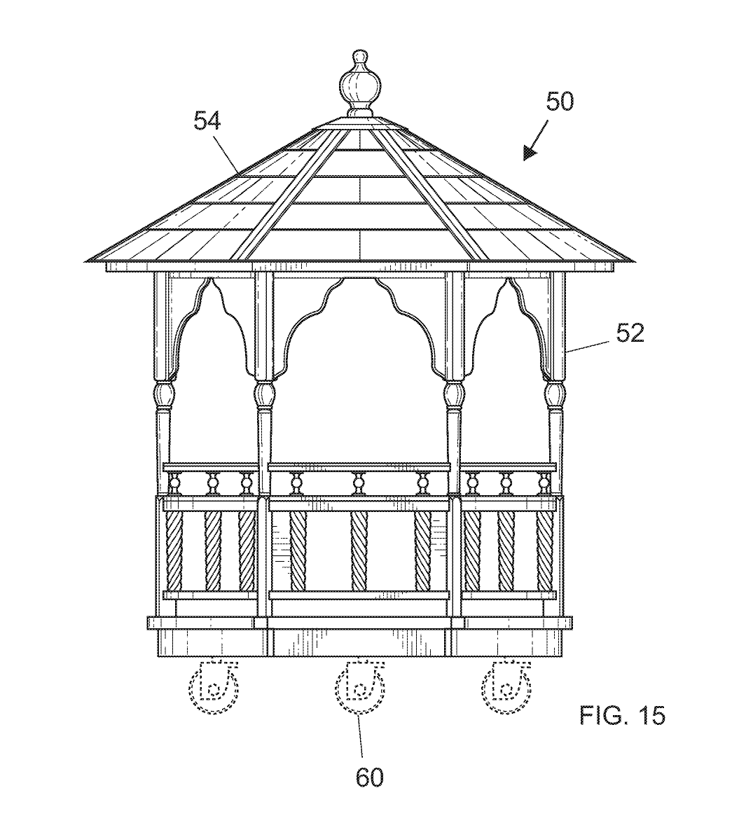

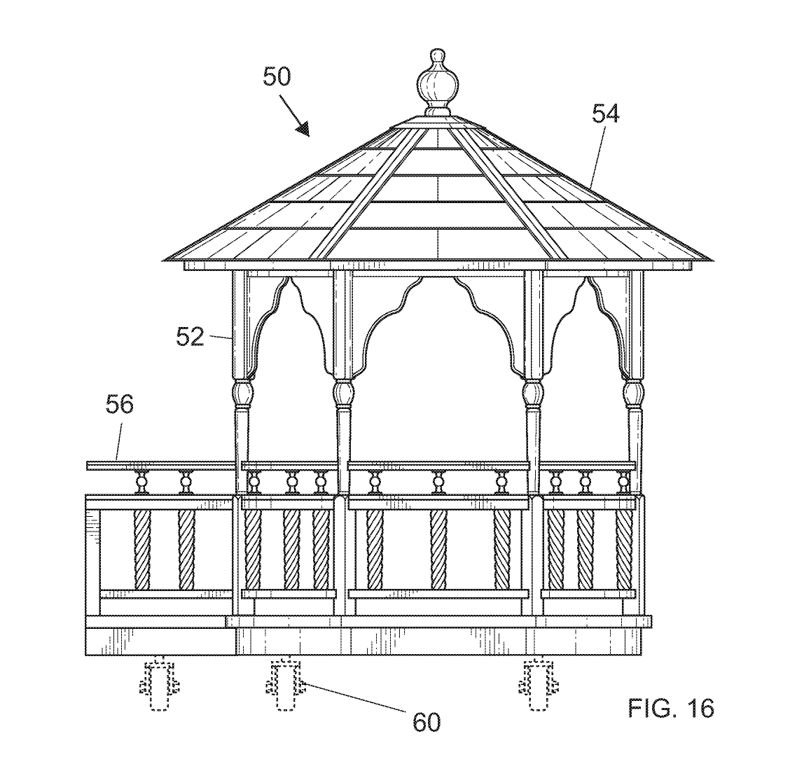

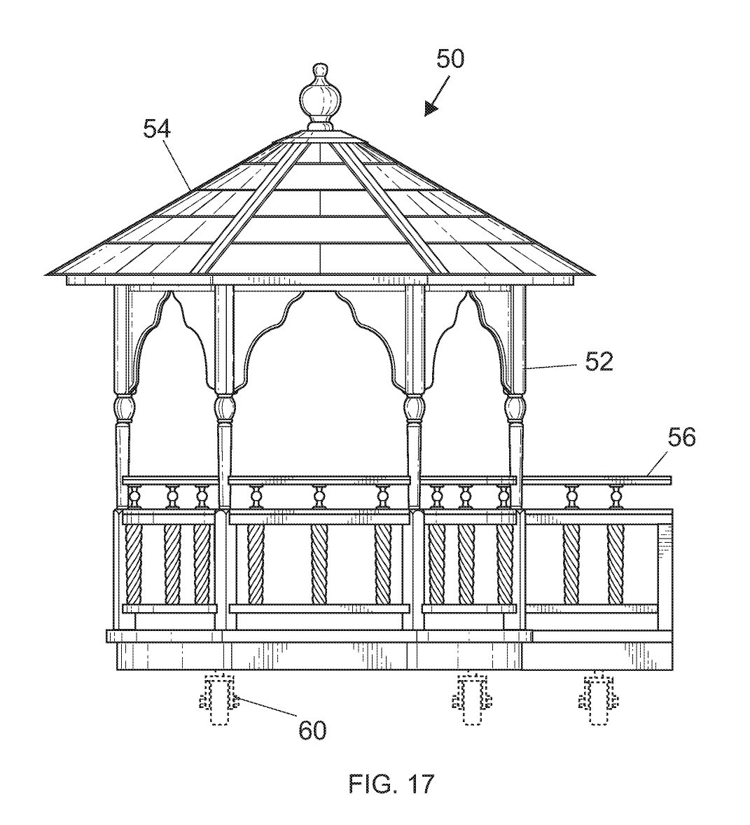

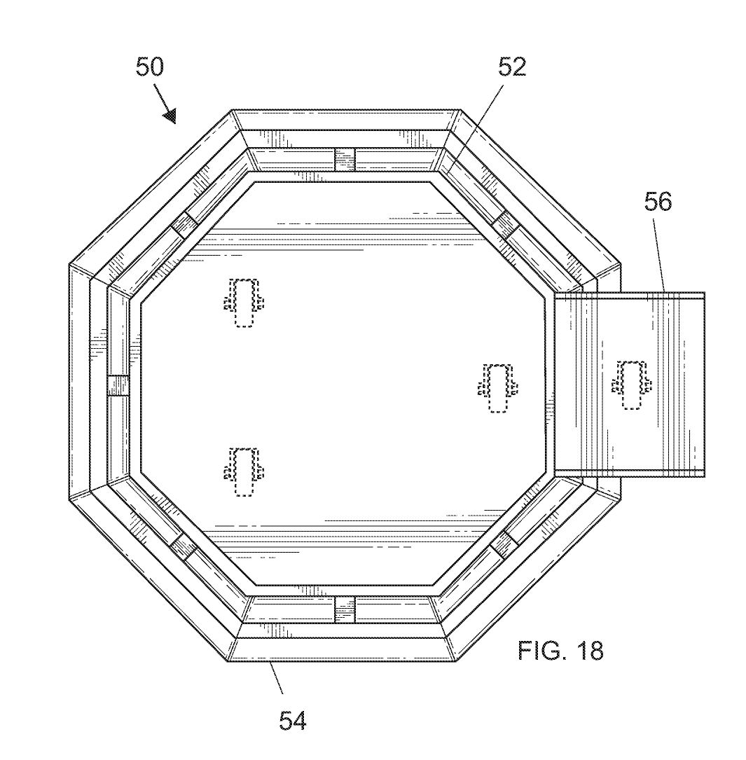

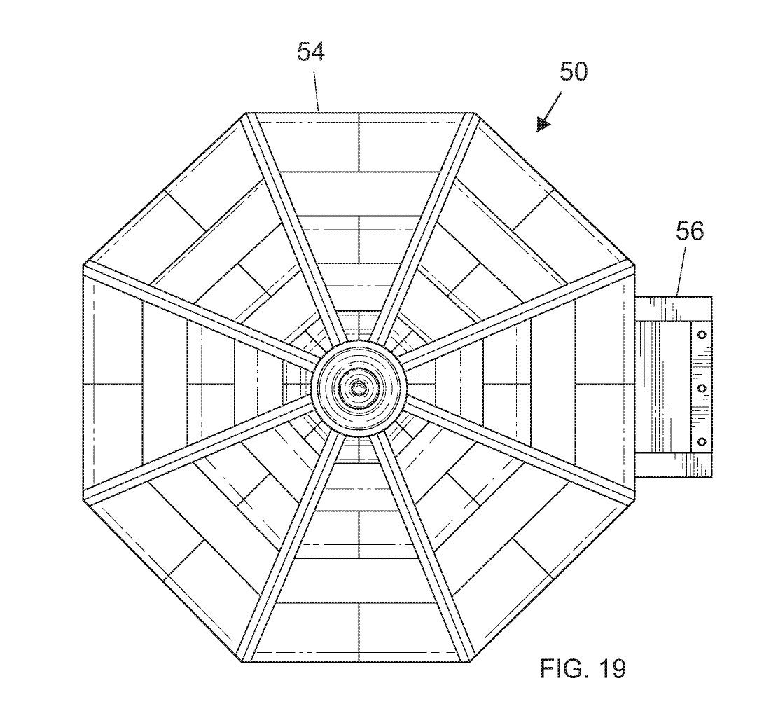

Further adaptation, variation, and supplementation of the home for pets 10 are possible and within the scope of the invention. Once such advantageous supplementation is a pet gazebo 50 as is depicted in FIGS. 13-22. The gazebo 50 can stand independently and can be removably coupled to the building structure 12 of the home for pets 10. As seen, for instance, in FIG. 13, the gazebo 50 can be founded on an open frame structure 52 including railings and posts. The frame structure 52 can be octagonal in shape with an abbreviated gangway 56 forming one of the sides. The gangway 56 has an overhanging tongue 58. The gazebo 50 can be disposed on caster wheels 60 to permit relocation and reorientation of the gazebo 50 and the home for pets 10 in general.

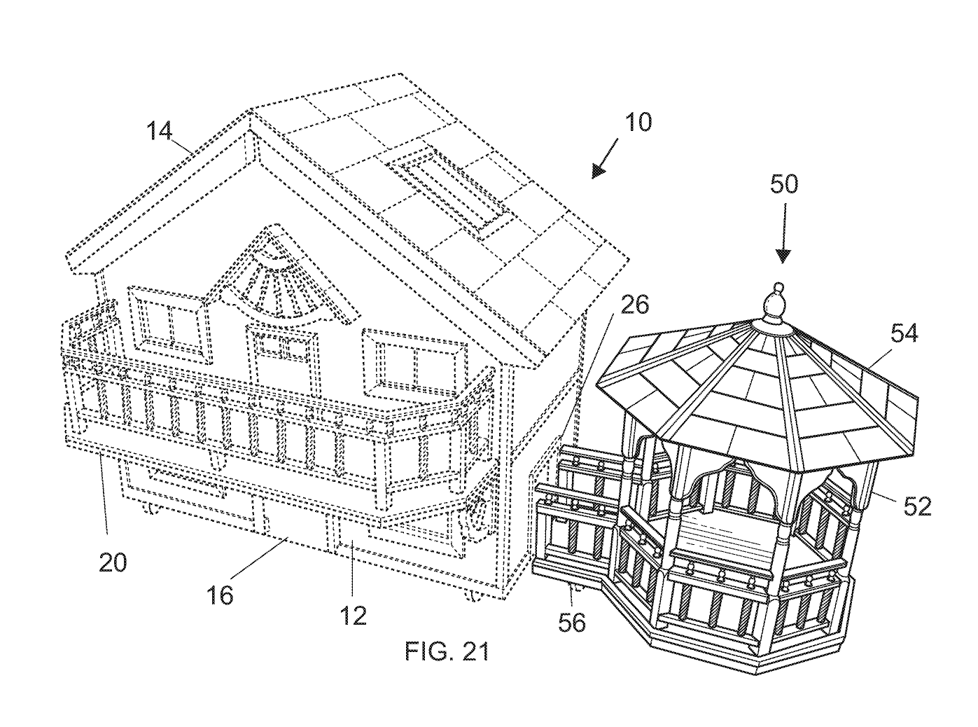

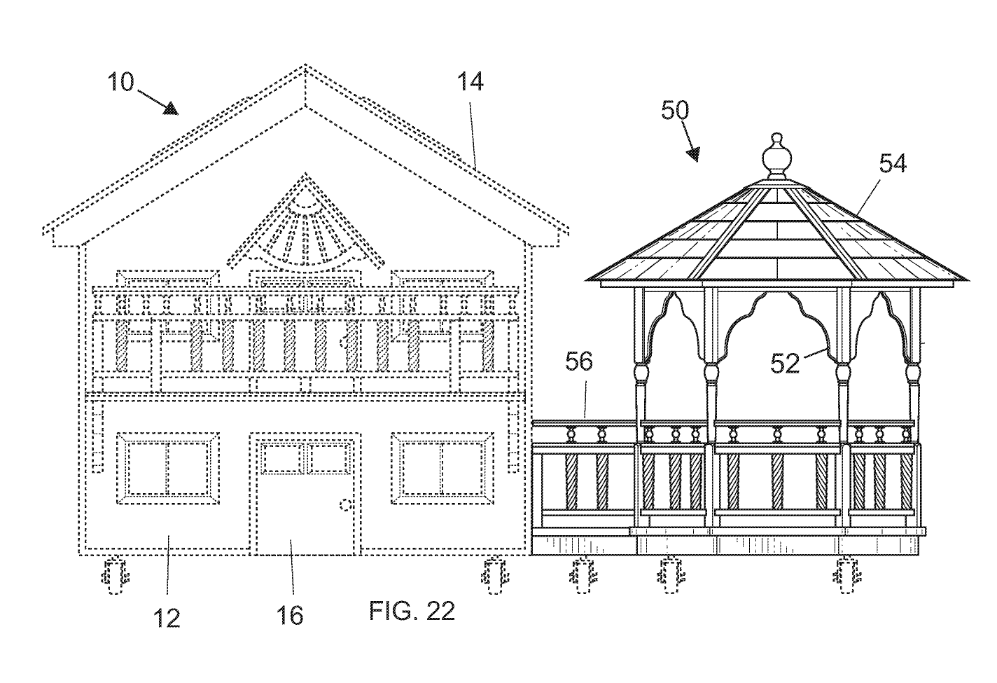

As shown in FIGS. 21 and 22, the gazebo 50 can be cooperatively engaged with the building structure 12 by causing the gangway 56 to be aligned with the doorway 26 in the right sidewall of the building structure 12. The tongue 58 or the gangway 56 itself could be fastened to the main building structure 12, such as through mechanical fasteners, a mating engagement, adhesive, or some other fastening mechanism or combination thereof. With the building structure 12 and the gazebo 50 so engaged, a pet, while still in the home for pets 10, could traverse from within the sheltered confines of the main building structure 12 to the openness of the gazebo 50 and back again at his or her leisure.

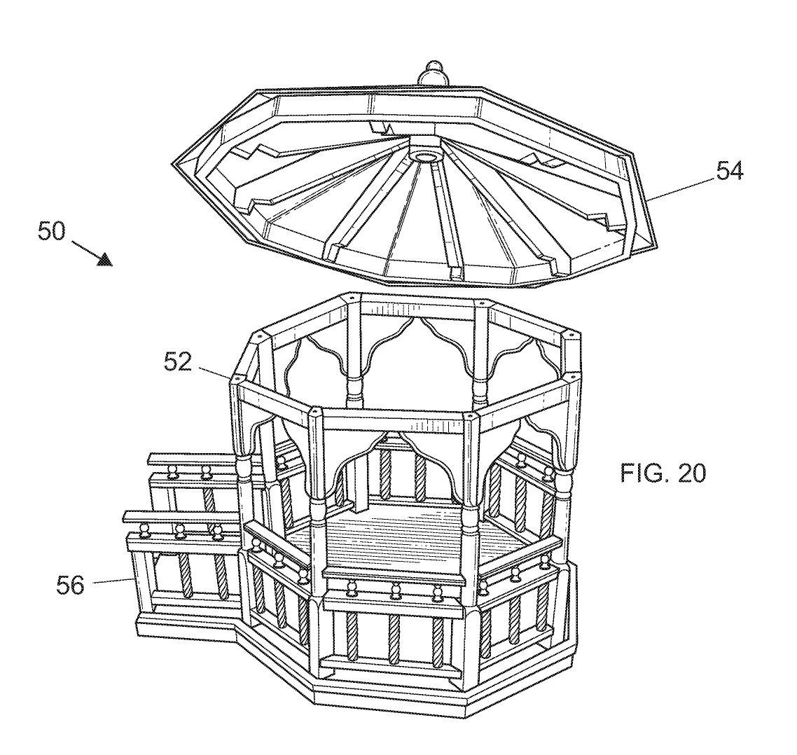

A roof 54 can be disposed atop the frame structure 52 for enclosing the top of the gazebo 50. The roof 54 can match the cross-sectional shape of the frame structure 12. As shown in FIG. 20, the roof 54 can merely rest on the frame structure 52 such that it can be readily removed and replaced, such as to permit cleaning, maintenance, and access to a pet within the gazebo 50. In this example, the roof 54 has a plurality of notched rafters for mechanically engaging the frame structure 52. Roofing material, such as real or simulated wooden sheets with shingles thereon, can be retained by the rafters.

The home for pets 10 is configured and proportioned specifically to permit and encourage use by pets, such as the dog indicated at 100 in FIG. 1. The overall size of the home for pets 10 may vary depending on the pet 100 to be accommodated. A relatively small home for pets 10 may be ideal for a small breed, such as a Chihuahua, but a larger home for pets 10 may be required for a large breed of dog, such as a Golden Retriever. For instance, in one embodiment, the home 10 could be designed for a small dog breed and could have a height of roughly four feet, three inches, and approximately five feet in length. Homes 10 for medium and large breed dogs would be proportionately larger.

In any such event, however, the home for pets 10 will ideally be of such proportion that the pet 100 can pass through the doors 16, 18, and 26, travel up and down the vertical communication connection 46, and enjoy the gazebo 50 where applicable preferably while accommodating the competing concern of providing as much open floor space on the first and second floors 62 and 64 as possible. For example, to permit easy ingress and egress of the pet 100, the first and second floor doors 16 and 18 could be between approximately 20-25%, potentially 22-23%, as wide as the overall width of the front wall of the building structure 12. Moreover, to permit the pet 100 to travel up and down the stairway 46 while preserving floor space, the stairway 46 could be between 40-50%, potentially 44%, of the overall depth of the first and second floor flooring 42 and 44 or the building structure 12 in general. Still further, to permit the stairway 46 to be maneuvered by an animal, the steps of the stairway 46 could be larger than normal in proportion to the building structure 12. For example, the stairway 46 could have approximately five steps, such that each step of the stairway traverses 20% of the height difference between the first floor flooring 42 and the second floor flooring. Further adaptations and proportional details of the home for pets 10 can be appreciated with additional reference to the drawings.

Within the scope of the invention, the home for pets 10 could be prefabricated, or it could be provided in kit form for assembly by the consumer. The home for pets 10 could be crafted from any suitable material or combination thereof. For instance, the building structure 12 could be primarily crafted of wood with the windows being plastic or tempered glass. Some or all of the home for pets 10, such as decorative elements and other components, could be formed from plastic or metal. The exterior of the home for pets 10 could be treated with a weather-resistant finish to protect the animal and the home 10 in general. It is also contemplated that interior and/or exterior sensors 35 and 37 could be employed to open and close the doors 16 and 18 and to perform other automated functions for the convenience of the pet 100 and the efficient operation of the home 10. It is also contemplated that the electrical subsystem 36 could incorporate one or more monitoring cameras and/or microphones to permit remote monitoring of the pet 100, such as via a dedicated monitor or a computer or phone operating with specialized software. It is also contemplated that additional floors beyond the first and second floors 62 and 64 could be provided. Still further, it would be possible to include working plumbing fixtures, such as a water supply with an automatic filling and shutoff system for hydration. Water flow can also be provided for toilet and other hygienic functions.

With certain details and embodiments of the present invention for a multi-level, accessible home for pets 10 disclosed, it will be appreciated by one skilled in the art that changes and additions could be made thereto without deviating from the spirit or scope of the invention. This is particularly true when one bears in mind that the presently preferred embodiments merely exemplify the broader invention revealed herein. Accordingly, it will be clear that those with certain major features of the invention in mind could craft embodiments that incorporate those major features while not incorporating all of the features included in the preferred embodiments.

Therefore, the following claims shall define the scope of protection to be afforded to the inventor. Those claims shall be deemed to include equivalent constructions insofar as they do not depart from the spirit and scope of the invention. It must be further noted that a plurality of the following claims may express certain elements as means for performing a specific function, at times without the recital of structure or material. As the law demands, any such claims shall be construed to cover not only the corresponding structure and material expressly described in this specification but also all equivalents thereof.

I claim as deserving the protection of Letters Patent:

1. A multi-level, accessible home for pets, the home for pets comprising:
a building structure with at least a first story with first floor flooring, a second story with second floor flooring, a plurality of outer walls, and a roof supported by the outer walls wherein the outer walls and the roof of the building structure cooperate to define an inner volume of the building structure;
a first floor door disposed in an outer wall of the building structure for permitting ingress and egress relative to first story of the building structure; and
a vertical communication connection that connects the first floor flooring to the second floor flooring.

2. The home for pets of claim 1 further comprising a second floor door disposed in an outer wall of the building structure for permitting ingress and egress relative to the second story of the building structure.

3. The home for pets of claim 2 further comprising a porch retained by the building structure adjacent to the second floor door.

4. The home for pets of claim 3 further comprising plural windows disposed in the outer walls of the building structure.

5. The home for pets of claim 1 wherein at least a portion of the roof is adjustable from a first position adjacent to at least one of the outer walls of the building structure and a second, open position permitting access to the inner volume of the building structure.

6. The home for pets of claim 1 further comprising an indoor/outdoor sustenance retention system wherein at least a portion of the sustenance retention system is adjustable between a retracted position and an extended position.

7. The home for pets of claim 6 wherein the portion of the sustenance retention system is disposed exterior to the building structure when the portion of the sustenance retention system is in an extended position.

8. The home for pets of claim 7 wherein the portion of the sustenance retention system is automatically actuated.

9. The home for pets of claim 8 further comprising a sensor for sensing a location of a pet and wherein the portion of the sustenance retention system is automatically actuated by operation of the sensor.

10. The home for pets of claim 8 wherein the portion of the sustenance retention system is automatically actuated based on a timer.

11. The home for pets of claim 1 further comprising an electrical subsystem.

12. The home for pets of claim 11 wherein the electrical subsystem includes at least one electrical socket and at least one light.

13. The home for pets of claim 1 wherein the vertical communication connection comprises a stairway.

14. The home for pets of claim 1 wherein at least the roof of the home for pets is removable.

15. The home for pets of claim 14 wherein the second story and the roof are removable as a unit.

16. The home for pets of claim 15 wherein the second floor flooring is not removable with the second story and the roof.

17. The home for pets of claim 1 wherein the first floor door is disposed in an outer wall of the building structure wherein the first floor door and the outer wall have a width and wherein the width of the first floor door is between approximately 20-25% of the width of the outer wall.

18. The home for pets of claim 1 wherein the building structure has a depth, wherein the vertical communication connection that connects the first floor flooring to the second floor flooring has a depth, and wherein the depth of the vertical communication connection is between approximately 40-50% of the depth of the building structure.
